(19) United States
(12) Patent Application Publication
(10) Pub. No.: US 2009/0182758 A1
(43) Pub. Date: Jul. 16, 2009

(54) SYSTEM AND COMPUTER PROGRAM PRODUCT FOR AUTOMATICALLY COMPUTING PROFICIENCY OF PROGRAMMING SKILLS

(75) Inventors: Rohit Manohar Lotlikar, Bangalore (IN); Nandakishore Kambhatla, Bangalore (IN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/972,897

(22) Filed: Jan. 11, 2008

(51) Int. Cl. G06F 17/30

(52) U.S. Cl. 707/102; 707/E17.044

(57) ABSTRACT

Techniques for automatically computing a programmer proficiency rating for one or more programmers are provided. The techniques include obtaining one or more programmer artifacts for each programmer to be assessed, obtaining one or more programmer artifacts and one or more human proficiency ratings for a separate set of one or more programmers, training a first module to learn a rating model from the one or more programmer artifacts and one or more human proficiency ratings for the separate set of one or more programmers, and using a second module to apply the rating model to the one or more programmer artifacts for each programmer to be assessed to automatically generate the programmer proficiency rating for each programmer. Techniques are also provided for generating a database of one or more programmer proficiency ratings.

### CROSS-REFERENCE TO RELATED APPLICATIONS

The present application is related to a commonly assigned U.S. application entitled “Method for Automatically Computing Proficiency of Programming Skills,” identified by attorney docket number IN920070074US1, and filed on even date herewith, the disclosure of which is incorporated by reference herein in its entirety.

### FIELD OF THE INVENTION

The present invention generally relates to information technology, and, more particularly, to proficiency assessment.

### BACKGROUND OF THE INVENTION

Challenges exist is the area of assessing proficiency of programming skills. Existing approaches assess proficiency manually by human assessors. Existing approaches also include a high operation cost, especially when a large number of invidivuals are being assessed on an ongoing basis (because people's skills evolve). However, there also exists a high cost for not performing proficiency assessments. Neglecting such assessments can lead to improper or detrimental matching of skills to project requirements.

### SUMMARY OF THE INVENTION

Principles of the present invention provide techniques for automatically computing proficiency of programming skills from programmer artifacts.

An exemplary method (which may be computer-implemented) for automatically computing a programmer proficiency rating for one or more programmers, according to one aspect of the invention, can include steps of obtaining one or more programmer artifacts for each programmer to be assessed, obtaining one or more programmer artifacts and one or more human proficiency ratings for a separate set of one or more programmers, training a first module to learn a rating model from the one or more programmer artifacts and one or more human proficiency ratings for the separate set of one or more programmers, and using a second module to apply the rating model to the one or more programmer artifacts for each programmer to be assessed to automatically generate the programmer proficiency rating for each programmer.

In an embodiment of the invention, an exemplary method for generating a database of one or more programmer proficiency ratings includes the following steps. One or more programmer artifacts for each programmer are obtained. Data analysis is performed on the one or more programmer artifacts to compute one or more program quality features. The one or more program quality features and one or more classification techniques are used to compute a programmer proficiency raring for one or more programmers. Also, the programmer proficiency rating is stored in a searchable database.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an exemplary programmer rating training module (PRTM), according to an embodiment of the present invention;

FIG. 2 is a diagram illustrating an exemplary programmer ratine module (PRM), according to an embodiment of the present invention;

FIG. 3 is a flow diagram illustrating techniques for automatically computing a programmer proficiency rating for one or more programmer, according to an embodiment of the present invention;

FIG. 4 is a flow diagram illustrating techniques for generating a database of one or more programmer proficiency ratings, according to an embodiment of the present invention; and

FIG. 5 is a system diagram of an exemplary computer system on which at least one embodiment of the present invention can be implemented.

### DETAILED DESCRIPTION OF PREFERRED EMBODIMENTS

Principles of the present invention include assessing technical skill levels of information technology (IT) programmers. One or more embodiments of the invention include using automatically computed program quality features, as well as using classifiers to learn programmer proficiency from training data. Additionally, principles of the invention include computing the proficiency of a programmer from the programmer artifacts that are created in the normal course of software development.

As described herein, principles of the invention include automatically assessing proficiency of programming skills of individuals using statistical learning techniques. The techniques detailed herein greatly reduce the need for human (that is, manual) assessment of programming skills of individuals, and lead to better matching of individuals to project requirements (for example, in a software group or in a services group).

One or more embodiments of the present invention improve the uniformity of assessment across an organization, minimize human effort required for ranking practitioners, and also can be implemented as an application to various organizations.

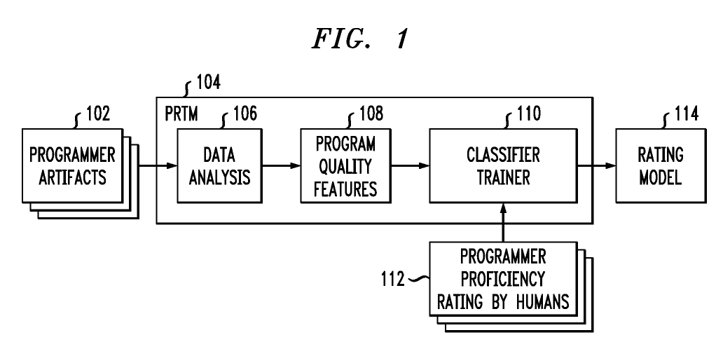

FIG. 1 is a diagram illustrating an exemplary programmer rating training module (PRTM), according to an embodiment of the present invention. By way of illustration, FIG. 1 depicts elements including programmer artifacts 102, PRTM 104 (which includes the elements of data analysis 106, program quality features 108 and classifier trainer 110), programmer proficiency rating by humans 112 and rating model 114.

As illustrated in FIG. 1, one or more embodiments of the present invention include a programmer rating training module (PRTM). A PRTM may include the capability to obtain a collection of items such as, for example, program artifacts (for example, Java programs and design documents authored by programmers) and human ratings of proficiency for a set of programmers. For each pair of items (for example, program artifacts and human ratings of proficiency), a data analysis can be performed on, for example, programmer artifacts, to compute program quality features. Also, for each pair of items, a classifier trainer can be applied to update a rating model using the program quality features and human ratings of proficiency.

The step of applying a classifier trainer can be iterated, for example, until the rating model converges for given classifier trainer. Also, the output of a PRTM is a rating model.

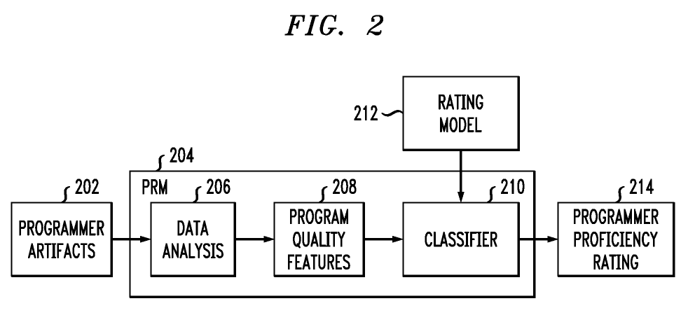

FIG. 2 is a diagram illustrating an exemplary programmer rating module (PRM), according to an embodiment of the present invention. By way of illustration, FIG. 2 depicts elements including programmer artifacts 202, PRM 204 (which includes the elements of data analysis 206, program quality features 208 and classifier 210), rating model 212 and programmer proficiency rating 214.

As illustrated in FIG. 2, one or more embodiments of the invention include a programmer rating module (PRM). As described herein, for each programmer to be assessed, program artifacts are collected for the programmer and data analysis is performed on the programmer artifacts to compute program quality features. A classifier can be applied to obtain the programmer proficiency rating for the programmer using the rating model and the computed program quality features. Also, an output of a PRM is a programmer proficiency rating for each programmer.

One difference between FIG. 1 and FIG. 2 (and between PRTM and PRM) is that the classifier trainer 110 is different from the classifier 210. The classifer trainer 110 learns and outputs a rating model 114 from human proficiency ratings 112, and sets of program quality features 108 (which are, in turn, generated by a data analysis module 106 that analyzes programmer artifacts 102).

The classifier 210, in contrast, applies the previously learnt rating model 114 (or 212) to automatically generate programmer proficiency ratings 214 from program quality features 108 (or 208), which are in turn generated by the data analysis module 106 (or 206) that analyzes programmer artifacts 102 (or 202).

During the operation of the PRTM operation, the PRTM infers a relationship between the program quality features and proficiency ratings by humans for a subset of the programmers. This relationship is encoded within the rating model. The rating model is the output of the PRTM, and is used by the PRM.

Operating the PRM includes outputting a proficiency rating for a programmer using the programmer artifacts. For example, an organization has 10,000 programmers. A small subset of 1,000 programmers (10%) are rated by humans. The PRTM would use programmer artifacts and humans ratings of these 1,000 programmers to output the rating model. The PRM would use this rating model to compute the programmer proficiency ratings for all 10,000 programmers, including the 9,000 that were unassessed by humans.

With a properly designed PRTM and PRM, the PRM outputs a proficiency rating close to what a human assessor would have typically assigned (and as part of the classifier training, this is checked for the 1,000 available human assessments), while ironing out the variations between human assessors.

The PRTM is used to output the rating model, and thereafter used periodically to update or tune the rating model as additional or fresh assessments by humans are made available.

As described herein, one or more embodiments of the present invention include programmer artifact(s), classifier trainer(s), classifier(s), rating model(s), programmer proficiency rating(s), and programmer proficiency rating(s) by humans. Programmer artifacts may include, for example, design documents, programs (that is, code), etc. written by a developer (for example, in the past few months or years) that may also be filtered by language and/or platform. A classifier trainer may include training modules for classifiers such as, for example, a support vector machine (SVM), linear classifiers, maximum entropy, neural networks, etc.

A classifier may include run-time classification modules for classifiers such as, for example, SVM, linear classifiers, maximum entropy, neural networks, etc. A rating model may include a trained model output by a classifier trainer (for example, for SVM, linear classifiers, etc.) that is used by a corresponding classifier to obtain programmer proficiency ratings. Programmer proficiency rating includes a rating of the programming skill of a programmer (for example, on a scale of 1-5 (5 being a skilled programmer, and 1 being a novice programmer). Also, programmer proficiency rating(s) by humans include a programmer proficiency rating (as described above) assessed by a human.

One or more embodiments of the present invention may also include data analysis and program quality features. Data analysis may include, for example, a module that computes program quality features used by classifier trainers and classifiers using programmer artifacts.

Program quality features include features (that is, statistics or any computed quantity) that convey useful information about the quality of programs. Such features may include, for example, average number of classes used, number of global variables used, number of static variables used, number of lines of code per method, number of side effects of methods, number of private and public instance variables, interfaces used, inherited classes used, inner classes used, etc. Additional features may include, for example, defect rates (for example, standard measures such as defects per kilo-line of code or defects per function point).

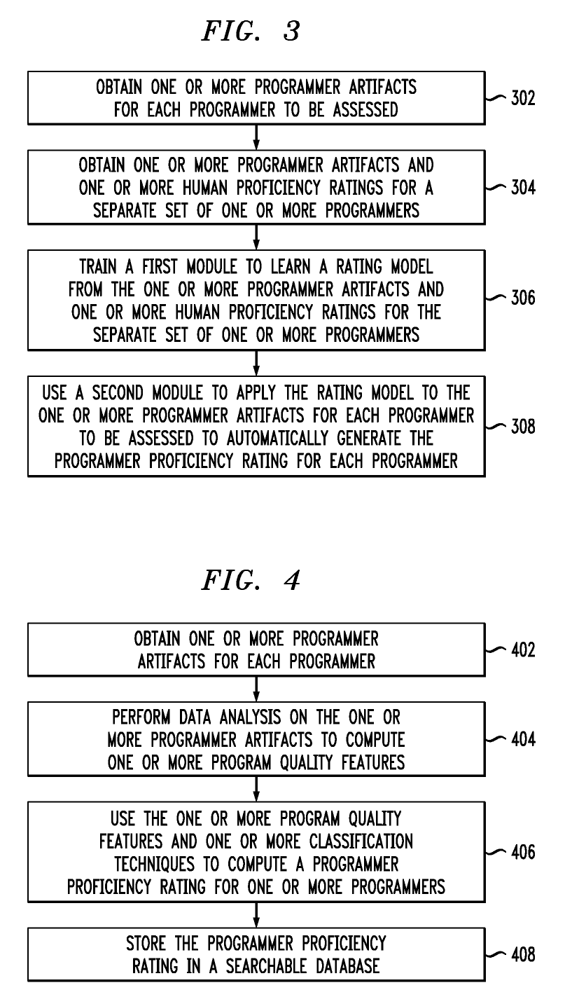

FIG. 3 is a flow diagram illustrating techniques for automatically computing a programmer proficiency rating for one or more programmers, according to an embodiment of the present invention. Step 302 includes obtaining one or more programmer artifacts for each programmer to be assessed. Programmer artifacts may include, for example, design documents, artifacts commonly found in the development process such as, for example, defect rates and productivity measures, and programs written by a developer, wherein the programs are filtered by at least one of language and platform. Step 304 includes obtaining one or more programmer artifacts and one or more human proficiency ratings for a separate set of one or more programmers.

Step 306 includes training a first module (for example, a PRTM) to learn a rating model from the one or more programmer artifacts and one or more human proficiency ratings for the separate set of one or more programmers. Training the first module can include performing a data analysis on the one or more programmer artifacts to compute one or more program quality features, and using a classifier trainer to learn a rating model from the program quality features and proficiency ratings by human assessors for the separate set of programmers. Data analysis can be performed automatically by using computer programs that parse the code to identify various elements in the source code, followed by numeric computations to compute the quality features. In an illustrative embodiment of the invention, a rule-based approach may be used to identify various elements in the source code.

Also, a classifier trainer may be trained, for example, to mimick human assessors using proficiency ratings computed by humans for a subset of the one or more programmers. The classifier trainer (for example, a program) will learn to rate the proficiency of programmers from a set of previous examples.

Program quality features may include, for example, average number of classes used, average number of lines of code per method, average number of global variables used, average number of static variables used, average number of interfaces used, average number of inherited classes used, average defect rates, average number of side effects of methods, average number of private and public instance variables, average number of inner classes used and productivity measures.

Step 308 includes using a second module (for example, a PRM) to apply the (learnt) rating model to the programmer artifacts for each programmer to be assessed to automatically generate the programmer proficiency rating for each programmer. The programmer proficiency rating may include, for example, a rating of a programming skill of a programmer. Also, the techniques depicted in FIG. 3 may also include outputting the programmer proficiency rating for each programmer (for example, to a user).

FIG. 4 is a flow diagram illustrating techniques for generating a database of one or more programmer proficiency ratings, according to an embodiment of the present invention. Step 402 includes obtaining one or more programmer artifacts for each programmer. Step 404 includes performing data analysis on the one or more programmer artifacts to compute one or more program quality features. Step 406 includes using the one or more program quality features and one or more classification techniques to compute a programmer proficiency rating for one or more programmers. Classification techniques may include, but are not limited to, for example, a support vector machine (SVM), one or more linear classifiers, one or more neural networks and maximum entropy. Step 408 includes storing the programmer proficiency rating in a searchable database.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

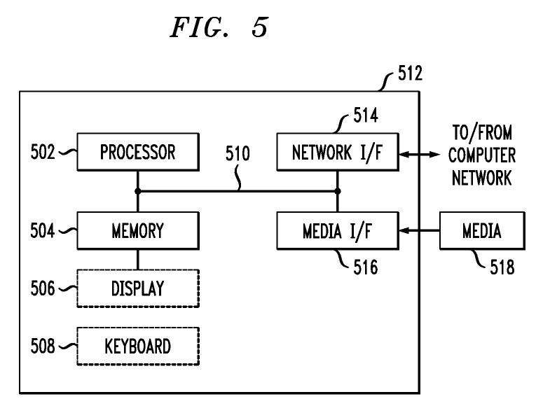

At present, it is believed that the preferred implementation will make substantial use of software running on a general-purpose computer or workstation. With reference to FIG. 5, such an implementation might employ, for example, a processor 502, a memory 504, and an input and/or output interlace formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 502, memory 504, and input and/or output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 518) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 504), magnetic tape, a removable computer diskette (for example, media 518), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A system, preferably a data processing system suitable for storing and/or executing program code will include at least one processor 502 coupled directly or indirectly to memory elements 504 through a system bus 510. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 508, displays 506, pointing devices, and the like) can be coupled to the system either directly (such as via bus 510) or through intervening I/O controllers (omitted for clarity).

Network adapters such as network interlace 514 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, improving the uniformity of assessment across and organization and minimizing human effort required for ranking practitioners.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer program product comprising a computer useable medium having computer useable program code for automatically computing a programmer proficiency rating for one or more programmers, said computer program product including:
computer useable program code for obtaining one or more programmer artifacts for each programmer to be assessed;
computer useable program code for obtaining one or more programmer artifacts and one or more human proficiency ratings for a separate set of one or more programmers;
computer useable program code for training a first module to learn a rating model from the one or more programmer artifacts and one or more human proficiency ratings for the separate set of one or more programmers; and
computer useable program code for using a second module to apply the rating model to the one or more programmer artifacts for each programmer to be assessed to automatically generate the programmer proficiency rating for each programmer.

2. The computer program product of claim 1, wherein the one or more programmer artifacts comprise at least one of one or more design documents, one or more defect rates, one or more productivity measures and one or more programs written by a developer, wherein the one or more programs are filtered by at least one of language and platform.

3. The computer program product of claim 1, wherein the computer useable program code for training a first module further comprises:
computer useable program code for performing a data analysis on the one or more programmer artifacts to compute one or more program quality features; and
computer useable program code for using a classifier trainer to learn a rating model from the one or more program quality features and one or more proficiency ratings by one or more human assessors for the separate set of one or more programmers.

4. The computer program product of claim 3, wherein computer useable program code for using a classifier trainer further comprises:
computer useable program code for training the classifier trainer to mimick one or more human assessors using one or more proficiency ratings by humans for a subset of the one or more programmers.

5. The computer program product of claim 1, wherein the programmer proficiency rating comprises a rating of a programming skill of a programmer.

6. A system for automatically computing a programmer proficiency rating for one or more programmers, comprising:
a memory; and
at least one processor coupled to said memory and operative to:
obtain one or more programmer artifacts for each programmer to be assessed;
obtain one or more programmer artifacts and one or more human proficiency ratings for a separate set of one or more programmers;
train a first module to learn a rating model from the one or more programmer artifacts and one or more human proficiency ratings for the separate set of one or more programmers; and
use a second module to apply the rating model to the one or more programmer artifacts for each programmer to be assessed to automatically generate the programmer proficiency rating for each programmer.

7. The system of claim 6, wherein the one or more programmer artifacts comprise at least one of one or more design documents, one or more defect rates, one or more productivity measures and one or more programs written by a developer, wherein the one or more programs are filtered by at least one of language and platform.

8. The system of claim 6, wherein the at least one processor coupled to said memory and operative to train the first module is further operative to:
perform a data analysis on the one or more programmer artifacts to compute one or more program quality features; and
use a classifier trainer to learn a rating model from the one or more program quality features and one or more proficiency ratings by one or more human assessors for the separate set of one or more programmers.

9. The system of claim 8, wherein the at least one processor coupled to said memory and operative to use a classifier trainer is further operative to:
train the classifier trainer to mimick one or more human assessors using one or more proficiency ratings by humans for a subset of the one or more programmers.

10. A computer program product comprising a computer useable medium having computer useable program code for generating a database of one or more programmer proficiency ratings, said computer program product including:
computer useable program code for obtaining one or more programmer artifacts for each programmer;
computer useable program code for performing data analysis on the one or more programmer artifacts to compute one or more program quality features;
computer useable program code for using the one or more program quality features and one or more classification techniques to compute a programmer proficiency rating for one or more programmers; and
computer useable program code for storing the programmer proficiency rating in a searchable database.

11. The computer program product of claim 10, wherein the one or more classification techniques comprise a support vector machine (SVM), one or more linear classifiers, one or more neural networks and maximum entropy.
